(19) United States
(12) Patent Application Publication
(10) Pub. No.: US 2026/0080867 A1
(43) Pub. Date: Mar. 19, 2026

(54) SPOKEN COMMAND SYSTEM AND METHOD THEREFOR

(71) Applicant: MOTOROLA SOLUTIONS, INC., CHICAGO, IL (US)

(72) Inventors: NIKEN LINDA DINARTIKA, BAYAN LEPAS (MY); CARMEN JIA YI SIAU, KOTA KINABALU (MY); SHINN WOEI OOI, GEORGETOWN (MY); KIN HEE WOO, GELANG PATAH (MY); CHIK YONG TAN, ULU KINTA (MY)

(21) Appl. No.: 18/889,487

(22) Filed: Sep. 19, 2024

(51) Int. Cl. G10L 15/22

(52) U.S. Cl. CPC G10L 15/22

(57) ABSTRACT

A spoken command system and method therefor is disclosed. The method includes processing a formatted command signal at a server which communicates with at least one mobile device (that is a subset of a plurality of mobile devices) to initiate therein the at least one operational action. In response to a successful initiation or a successful completion of the at least one operational action, the at least one mobile device is caused to emit a predefined messageless indication to permit a human to distinguish the subset of the mobile devices from the remaining devices of the plurality of mobile devices.

### BACKGROUND

In companies and other types of organizations that employ one or more teams of people, similar-looking devices may be assigned to some or all of the people. These similar-looking devices may be physically stored together before a work shift, for example, even though the functionalities and capabilities of these similar-looking devices may differ from each other.

Often looking at the outside appearance of each of the devices does not provide enough information to distinguish one particular device that is more desirable to be selected for a particular assignment than less desirable device(s) available to be selected. Furthermore, even when it may be hypothetically possible to distinguish devices based on something recognizable in the outside appearance, not everyone coming in contact with the devices may have knowledge of the distinguishing differences in appearance.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a spoken command system in accordance with example embodiments.

FIG. 2 is a flow chart illustrating a computer-implemented method in accordance with an example embodiment.

FIG. 3 is a diagram of a Body Worn Camera (BWC) device consistent with one or more examples of one type of mobile device that may form a part of the spoken command system of FIG. 1.

FIG. 4 is a diagram of a portable radio device consistent with one or more examples of another type of mobile device that may form a part of the spoken command system of FIG. 1.

FIG. 5 is a diagram of weapon equipment consistent with one or more examples of yet another type of mobile device that may form a part of the spoken command system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In accordance with one example embodiment, there is provided a method that includes receiving human spoken command instructions at a microphone as sound waves that are converted by the microphone into an audio signal. The method also includes employing speech recognition, by operation of at least one processor, to convert the audio signal into a formatted command signal that defines at least one operational action to be taken by at least one mobile device that is a subset of a plurality of mobile devices. The at least one operational action is applicable to the subset of the mobile devices, without being applicable to remaining devices of the plurality of mobile devices, based on device identifying criteria specified in the formatted command signal. The method also includes processing the formatted command signal at a server which communicates with the at least one mobile device to initiate therein the at least one operational action. In response to a successful initiation or a successful completion of the at least one operational action, the at least one mobile device is caused to emit a predefined messageless indication to permit a human to distinguish the subset of the mobile devices from the remaining devices of the plurality of mobile devices.

In accordance with another example embodiment, there is provided a system that includes a microphone configured to receive human spoken command instructions as sound waves that are converted by the microphone into an audio signal. The system also includes a plurality of mobile devices and at least one processor. The system also includes at least one electronic storage medium storing program instructions that when executed by the at least one processor cause the at least one processor to perform converting the audio signal, by employing speech recognition, into a formatted command signal that defines at least one operational action to be taken by at least one mobile device that is a subset of a plurality of mobile devices. The at least one operational action is applicable to the subset of the mobile devices, without being applicable to remaining devices of the plurality of mobile devices, based on device identifying criteria specified in the formatted command signal. The at least one mobile device is configured to initiate the at least one operational action therein in response to a processing of the formatted command signal. In response to a successful initiation or a successful completion of the at least one operational action, the at least one mobile device is configured to emit a predefined messageless indication to permit a human to distinguish the subset of the mobile devices from the remaining devices of the plurality of mobile devices.

Each of the above-mentioned embodiments will be discussed in more detail below, starting with example system and device architectures of the system in which the embodiments may be practiced, followed by an illustration of processing blocks for achieving an improved technical method, device, and system for voice commanding.

Example embodiments are herein described with reference to flowchart illustrations and/or block diagrams of methods, apparatus (systems) and computer program products according to example embodiments. It will be understood that at least some blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

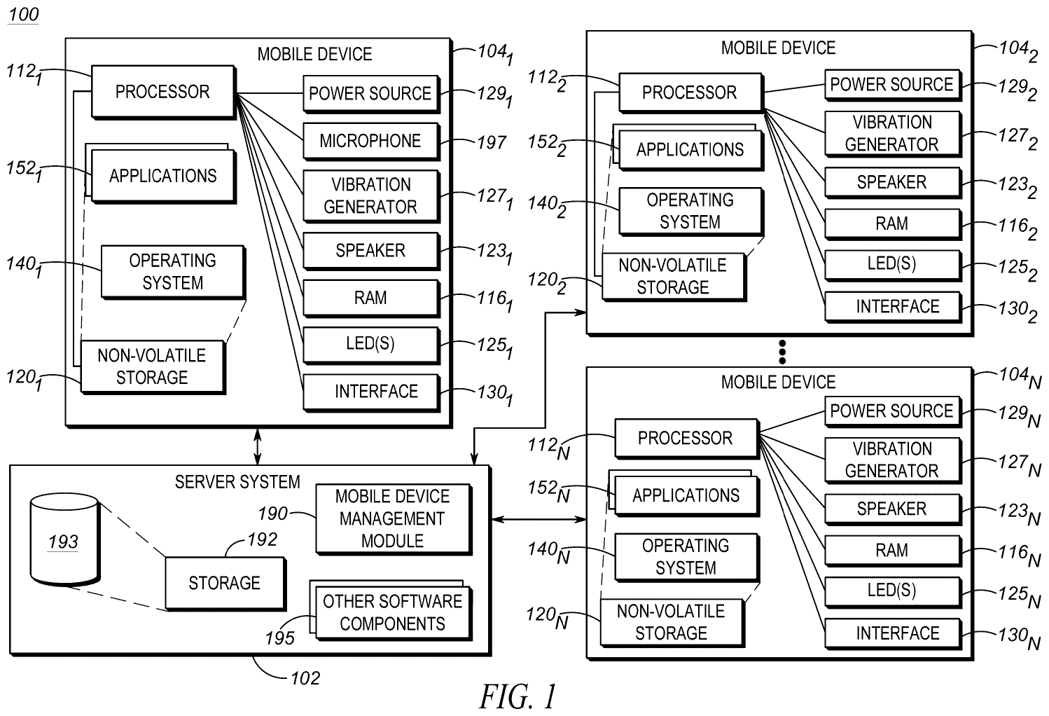

Referring now to the drawings, and in particular FIG. 1 which is a block diagram of a spoken command system 100 in accordance with example embodiments. The spoken command system 100 includes a server system 102 and a plurality of mobile devices 104₁-104_{N} (hereinafter interchangeably referred to as “mobile devices 104₁-104_{N}” when referring to all of the mobile devices, or “mobile device 104” when referring to any individual one of the plurality) where N is any suitable integer greater than two.

Regarding the server system 102, this includes a mobile device management module 190, and one or more storages 192 that include one or more databases 193. In some examples, the mobile device management module 190 may be configured to retrieve, store, modify and/or delete information in the databases(s) 193. The database(s) 193 may include records concerning the mobile devices 104₁-104_{N}, which may include information such as, for example, device serial numbers, firmware and/or software version numbers, device names, other device identifying details, etc.

The server system 102 also includes a number of other software components 195. These other software components will vary depending on the requirements of the server system 102 within the overall system. As one example, the other software components 195 might include special test and debugging software, or software to facilitate version updating of modules within the server system 102. In some examples, the server system 102 may be configured to provide a portal experience to users. In some examples, at least some parts of the server system 102 may be implemented in the cloud.

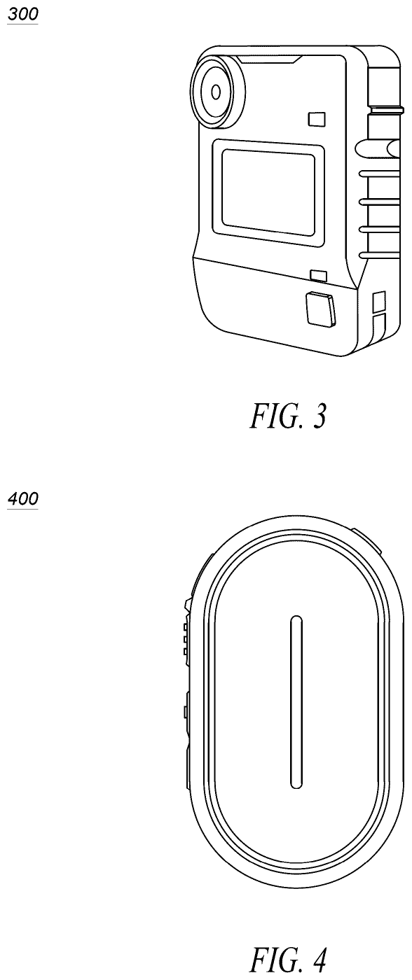

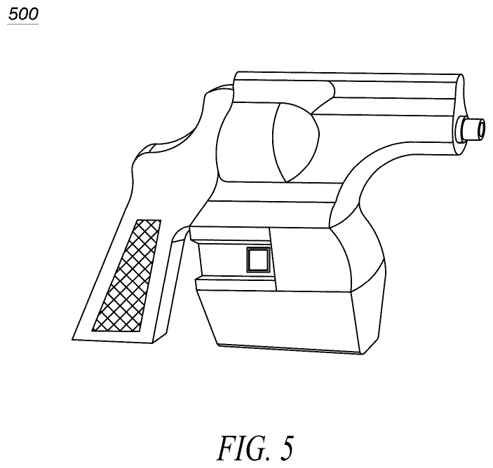

Still with reference to FIG. 1, different types of mobile devices, that communicate within the spoken command system 100, are contemplated. The mobile device 104 may be, for example, a Body Worn Camera (BWC) device (such as, for instance, BWC device 300 shown in FIG. 3), a portable radio device (such as, for instance, the portable radio device 400 shown in FIG. 4), weapon equipment (such as, for instance, the weapon equipment 500 shown in FIG. 5), etc.

The illustrated mobile device 104 shown in FIG. 1 includes at least one processor 112 that controls the overall operation of the mobile device. The processor 112 interacts with various subsystems such as, for example, random access memory (RAM) 116, non-volatile storage 120, speaker 123, one or more light emitting diodes (LED(s)) 125 and vibration generator 127. In some examples, the LED(s) 125 may be optionally integrated into a housing of the mobile device 104 (any suitable device components like, for instance, the speaker 123 and the vibration generator 127, may be optionally integrated into the housing of the mobile device 104). Also, those skilled in the art will appreciate that some of the illustrated device components of the mobile device 104 are optional device components. For example, the mobile device 104 may include the speaker 123 but lack one or both of the LED(s) 125 and the vibration generator 127, or the mobile device 104 may include the LED(s) 125 but lack one or both of the speaker 123 and the vibration generator 127, or the mobile device 104 may include the vibration generator 127 but lack one or both of the speaker 123 and the LED(s) 125.

The illustrated mobile device 104 also includes a power source 129 which provides operating power within the mobile device 104. In some examples, the power source 129 includes one or more batteries, a power supply with one or more transformers, etc.

The illustrated mobile device 104 lacks an electronic display configured to render text or graphics thereon. In some alternative examples, one or more of the mobile devices 104₁-104_{N} may include a display configured to render text or graphics thereon.

The illustrated mobile device 104 also includes interface 130. The interface 130 may include hardware, software, or both providing one or more interfaces for communication (such as, for example, packet-based communication) among the mobile device 104, other computing devices similar to the mobile device 104, any suitable networks, any suitable network devices, and/or any other suitable computer systems. As an example and not by way of limitation, the interface 130 may include a Network Interface Controller (NIC) or network adapter for communicating with an Ethernet or other wire-based network and/or a Wireless NIC (WNIC) or wireless adapter for communicating with a wireless network. In at least one example consistent with what is illustrated in FIG. 1, the interface 130 may include a USB port to support USB-compliant communications.

In some examples, the interface 130 comprises one or more wireless communication-enabling transceivers coupled to one or more physical antenna ports. Depending on the example implementation, the interface 130 may be any type of interface suitable for any type of suitable network with which the mobile device 104 is used. As an example and not by way of limitation, the mobile device 104 can communicate with an ad-hoc network, a Personal Area Network (PAN), a Local Area Network (LAN), a Wide Area Network (WAN), a Metropolitan Area Network (MAN), or one or more portions of the Internet or a combination of two or more of these. One or more portions of one or more of these networks may be wireless. As an example, the mobile device 104 may be capable of communicating with a Wireless PAN (WPAN) (such as, for example, a BLUETOOTH WPAN), a WI-FI™ network, a WI-MAX™ network, a Long-Term Evolution (LTE) network, an LTE-A network, a cellular telephone network (such as, for example, a Global System for Mobile Communications (GSM) network), or any other suitable wireless network or a combination of two or more of these. The mobile device 104 may include any suitable interface 130 for any one or more of these networks, where appropriate.

In some examples, the interface 130 may include one or more interfaces for one or more external I/O devices. These external I/O devices may include, for instance, a selected one or more of a keyboard, mouse, touch pad and roller ball, etc. An external I/O device may, and not by way of limitation, be any suitable input or output device, including alternatives more external in nature than other input devices (or output devices) herein mentioned (also, some combination of two or more of these is also contemplated). An external I/O device may include one or more sensors. Particular examples may include any suitable type and/or number of I/O devices and any suitable type and/or number of interfaces 130 for them. Where appropriate, the interface 130 may include one or more drivers enabling the processor 112 to drive one or more of these external I/O devices. The interface 130 may include one or more interfaces 130, where appropriate.

Still with reference to the mobile device 104, operating system 140 and various applications 152 used by the processor 112 are stored in the non-volatile storage 120. The non-volatile storage 120 is, for example, one or more hard disks, solid state drives, or some other suitable form of computer readable medium that retains recorded information after the mobile device 104 is turned off. Regarding the operating system 140, this includes software that manages computer hardware and software resources of the mobile device 104 and provides common services for computer programs. Also, those skilled in the art will appreciate that the operating system 140 and the applications 152, or parts thereof, may be temporarily loaded into a volatile store such as the RAM 116. The processor 112, in addition to its operating system functions, can enable execution of the applications 152 on the mobile device 104.

If the mobile device 104 is a “master” device (as explained later herein in further detail) then the mobile device will include at least one microphone. For example, the illustrated mobile device 104₁ is shown as including microphone 197 and is a master device. By contrast, the mobile devices 104₂ and 104₃ are shown as not including a microphone. A microphone is an optionally included component in respect of devices that are not the master device.

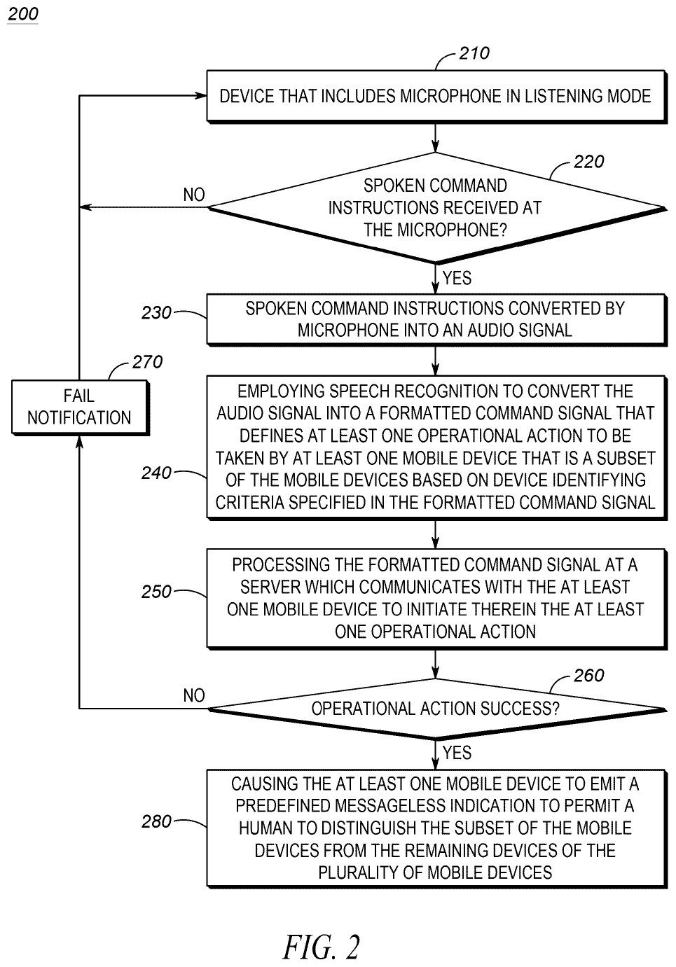

Reference is now made to FIG. 2. FIG. 2 is a flow chart illustrating a method 200 in accordance with an example embodiment.

In FIG. 2, the illustrated method 200 starts at 210 where a device that includes a microphone is in a listening mode. In some examples, this device is the mobile device 104₁ (FIG. 1) which includes the microphone 197. Also, the mobile device 104₁ may be understood to be a master device because it receives and processes commands. Also, the master device may, in some examples, be provided with a unique, privileged profile. By possessing this privileged profile, the master device may have capabilities for its role that distinguish the master device from other mobile devices (such as, for example, slave devices) that are not the master device.

Next in the method 200 is decision action 220, which is checking whether a spoken command has been received at the microphone (for example, the microphone 197). If “NO”, then the action 210 follows, and the device remains in the listening mode. If “YES”, then action 230 follows and the spoken command instructions are converted by the microphone into an audio signal.

Next in the method 200, speech recognition is employed (230) to convert the audio signal into a formatted command signal that is communicated by the transmitting device (such as, for instance, the master device) to a server (such as, for example, the server system 102). The formatted command signal defines at least one operational action to be taken by at least one mobile device that is a subset of a plurality of mobile devices. Consistent with a number of example embodiments, the at least one operational action is one or more of:
a sorting action (for example, not only revealing the device subset, but also providing an indication of ranking)
a filtering action (for example, showing a subset of radios currently belonging to some specific talkgroup)
a status changing action (for example, turning all radios in a particular talkgroup to “available” status, to “do not disturb” status, etcetera)
a group forming action (for example, creating a new talkgroup for radios in a device subset to join)
a device assignment action (for example, assigning certain privileges to certain devices that were provisioned within a defined period of time).

In at least some examples, the at least one operational action is applicable to the subset of the mobile devices, without being applicable to remaining devices of the plurality of mobile devices, based on device identifying criteria specified in the formatted command signal. For instance, and consistent with a non-limiting example, the at least one operational action might be applicable to the mobile device 104₂ but not applicable to the mobile device 104_{N}. Consistent with an alternative example, it could be that the at least one operational action is applicable to the mobile device 104_{N} but not applicable to the mobile device 104₂. Any suitable permutation of device(s) that form the above-mentioned subset of the plurality of mobile devices is contemplated.

The device identifying criteria mentioned above may be, for example, one or more specific device firmware versions; one or more software-specific operational statuses or states; one or more specific device battery states; one or more specific device operational modes; or one or more specific device provisioning particulars.

In at least one example, at least some of the devices outside of the subset of the plurality of mobile devices are outside of a defined maximum distance or maximum signal range from the master device.

Next in the method 200, the formatted command signal is processed (250) at a server (for example, by operation of mobile device management module 190 within the server system 102), and the server which communicates with the at least one mobile device (i.e. the device(s) in respect of which the at least one operational action is applicable) to initiate therein the at least one operational action.

Next in the method 200 is decision action 260, which is checking whether there has been operational success. If “NO”, then a fail notification may be provided (270). For example, the fail notification could be delivered via an audio feed that the speaker 123₁ outputs from the master device (or alternatively the fail notification could be delivered in some other suitable form). On the other hand, if “YES” follows from the decision action 260, then the at least one mobile device is caused to emit (280) a predefined messageless indication to permit a human to distinguish the subset of the mobile devices from the remaining devices of the plurality of mobile devices.

Various types of predefined messageless indications are contemplated. For example, the predefined messageless indication may be a predefined visual indication. In terms of the predefined visual indication, this may be, for instance, actuating one or more of the LED(s) 125 of the mobile device 104 for a defined time interval to provide a light emitting diode-based indication. In at least one example, the LED(s) 125 may take the form of a housing-integrated, light generation component configured to selectively provide the light emitting diode-based indication as a unique color from a repertoire of possible colors that the housing-integrated, light generation component possesses.

As another example, the predefined messageless indication may be a predefined sound indication produced by the speaker 123.

As yet another example, the predefined messageless indication may be a predefined vibration indication produced by the vibration generator 127.

In some examples, successful completion of the method 200 may include a success notification delivered via an audio feed that the speaker 123₁ outputs from the master device (or alternatively the success notification could be delivered in some other suitable form).

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, and, since the human mind lacks a transceiver, it cannot transmit commands to mobile electronic devices, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one”or “one or more”unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving human spoken command instructions at a microphone as sound waves that are converted by the microphone into an audio signal;
employing speech recognition, by operation of at least one processor, to convert the audio signal into a formatted command signal that defines at least one operational action to be taken by at least one mobile device that is a subset of a plurality of mobile devices, the at least one operational action being applicable to the subset of the mobile devices, without being applicable to remaining devices of the plurality of mobile devices, based on device identifying criteria specified in the formatted command signal;
processing the formatted command signal at a server which communicates with the at least one mobile device to initiate therein the at least one operational action; and
in response to a successful initiation or a successful completion of the at least one operational action, causing the at least one mobile device to emit a predefined messageless indication to permit a human to distinguish the subset of the mobile devices from the remaining devices of the plurality of mobile devices.

2. The method of claim 1 wherein the predefined messageless indication is at least one of a predefined visual indication, a predefined sound indication, and a predefined vibration indication.

3. The method of claim 2 wherein the predefined messageless indication is at least the predefined visual indication, and the predefined visual indication is a light emitting diode-based indication that is actuated for a defined time interval.

4. The method of claim 3 wherein each device of the subset of the mobile devices includes a respective housing-integrated, light generation component configured to selectively provide the light emitting diode-based indication as a unique color from a repertoire of possible colors that the housing-integrated, light generation component possesses.

5. The method of claim 1 wherein at least some of the plurality of mobile devices lack displays configured to render text or graphics thereon.

6. The method of claim 1 wherein:
the plurality of mobile devices includes a master device that includes the microphone, and
the master device is configured to communicate the formatted command signal to the server.

7. The method of claim 6 wherein the plurality of mobile devices other than the master device are slave devices configured to communicate with the server.

8. The method of claim 6 further comprising determining that at least some of the remaining devices of the plurality of mobile devices are outside of a defined maximum distance or maximum signal range from the master device.

9. The method of claim 1 where the at least one operational action is one or more of a sorting action, a filtering action, a status changing action, a group forming action, and a device assignment action.

10. The method of claim 9 wherein the device identifying criteria is:
one or more specific device firmware versions;
one or more software-specific operational statuses or states;
one or more specific device battery states;
one or more specific device operational modes; or
one or more specific device provisioning particulars.

11. The method of claim 1 wherein the subset of the mobile devices comprises one or more of at least one portable radio, at least one body worn camera, at least one sensor device, and weapon equipment.

12. A system comprising:
a microphone configured to receive human spoken command instructions as sound waves that are converted by the microphone into an audio signal;
a plurality of mobile devices;
at least one processor; and
at least one electronic storage medium storing program instructions that when executed by the at least one processor cause the at least one processor to perform:
converting the audio signal, by employing speech recognition, into a formatted command signal that defines at least one operational action to be taken by at least one mobile device that is a subset of a plurality of mobile devices, the at least one operational action being applicable to the subset of the mobile devices, without being applicable to remaining devices of the plurality of mobile devices, based on device identifying criteria specified in the formatted command signal, and
the at least one mobile device being configured to:
initiate the at least one operational action therein in response to a processing of the formatted command signal; and
in response to a successful initiation or a successful completion of the at least one operational action, emit a predefined messageless indication to permit a human to distinguish the subset of the mobile devices from the remaining devices of the plurality of mobile devices.

13. The system of claim 12 wherein the predefined messageless indication is at least one of a predefined visual indication, a predefined sound indication, and a predefined vibration indication.

14. The system of claim 13 wherein the predefined messageless indication is at least the predefined visual indication, and the predefined visual indication is a light emitting diode-based indication that is actuated for a defined time interval.

15. The system of claim 14 wherein each device of the subset of the mobile devices includes a respective housing-integrated, light generation component configured to selectively provide the light emitting diode-based indication as a unique color from a repertoire of possible colors that the housing-integrated, light generation component possesses.

16. The system of claim 12 wherein at least some of the plurality of mobile devices lack displays configured to render text or graphics thereon.

17. The system of claim 12 wherein:
the plurality of mobile devices includes a master device that includes the microphone, and
the master device is configured to communicate the formatted command signal to a server communicatively in-between the master device and the plurality of mobile devices other than the master device.

18. The system of claim 17 wherein the plurality of mobile devices other than the master device are slave devices configured to communicate with the server.

19. The system of claim 12 where the at least one operational action is one or more of a sorting action, a filtering action, a status changing action, a group forming action, and a device assignment action.

20. The system of claim 19 wherein the device identifying criteria is:
one or more specific device firmware versions;
one or more software-specific operational statuses or states;
one or more specific device battery states;
one or more specific device operational modes; or
one or more specific device provisioning particulars.
